(19) United States
(12) Patent Application Publication
(10) Pub. No.: US 2019/0388947 A1
(43) Pub. Date: Dec. 26, 2019

(54) Hollow Torque Transmission Member and Manufacturing Method Thereof, Intermediate Shaft, and Steering Apparatus for Automobile

(71) Applicant: NSK Ltd., Tokyo (JP)

(72) Inventors: Seiichi MORIYAMA, Maebashi-shi, Gunma (JP); Keisuke NAKAO, Maebashi-shi, Gunma (JP)

(21) Appl. No.: 16/481,194

(22) PCT Filed: Jan. 26, 2018
(86) PCT No.: PCT/JP2018/002457

§ 371 Date: Jul. 26, 2019

(30) Foreign Application Priority Data
Jan. 27, 2017 (JP) 2017-013517

(51) Int. Cl. B21D 15/03; B21D 53/88; B62D 1/19; B62D 1/20

(52) U.S. Cl. CPC B21D 15/03; B21D 53/88; F16D 3/74; B62D 1/20; B62D 1/192

(57) ABSTRACT

A structure of the hollow torque transmission member having a bellows portion in the middle section in the axial direction is manufactured at low cost by bulge molding such as hydroforming molding. A thin thickness portion having a smaller thickness in the radial direction than other portion is provided in the middle section in the axial direction of a hollow material. A hollow torque transmission member comprising a bellows portion is obtained by expanding the thin thickness portion outward in the radial direction by performing hydroforming molding to the hollow material.

### TECHNICAL FIELD

The present invention relates to a hollow torque transmission member of steering apparatus for an automobile and a manufacturing method thereof. Further, the present invention relates to an intermediate shaft where the hollow torque transmission member has been incorporated, as well as to steering apparatus for an automobile where this intermediate shaft has been incorporated.

### BACKGROUND ART

The steering apparatus for an automobile is formed so as to transmit the movement of a steering operated by a driver to a steering gear unit via a plurality of shafts such as a steering shaft and an intermediate shaft, and universal joints by which the end portions of these shafts are connected. When an automobile equipped with such steering apparatus causes a collision accident and a primary collision occurs, the front portion of the vehicle is crushed and the steering gear unit is pushed backward. In this case, even when the steering gear unit is displaced to the rear, it is important for the steering wheel so as not to be displaced backward and not to be pushed up toward the driver's body. It has been proposed to absorb an impact load in a primary collision by contracting or plastically deforming a torque transmitting member such as a shaft and a yoke of the steering apparatus and thus to prevent displacement of a steering wheel to the rear.

For example, EP1344708 (A1) and JPH0872730 (A) disclose a structure of a yoke comprising a bellows portion which is able to plastically deform in a primary collision so as to prevent displacement of the steering wheel to the rear.

Further, DE2459246 (A1) discloses a steering column comprising a bellows portion in the middle section in the axial direction which is able to contract its full length by plastically deforming this bellows portion based on the impact load due to a secondary collision. This steering column is able to adjust its absorption characteristics of an impact load due to a secondary collision by adjusting the thickness of the bellows portion. However, this technology is related to the steering column and it does not consider applying to a shaft or a yoke to which a force in a torsion direction due to the operation of the steering wheel while a vehicle is driving. Further, the deformation of the bellows portion when an impact load has been applied is only limited to an embodiment where the full length contracts.

On the other hand, for the steering shaft and the intermediate shaft, expansion and contraction function is required so as to contracts in the axial direction other than a purpose of functioning as absorbing an impact load that occurred in a primary collision. For example, for the steering shaft, the position of the steering wheel needs to be adjusted according to the physique and the driving position of a driver, so that an expansion and contraction function is required. Further, in the intermediate shaft, in order not to transmit the vibration of the wheels to the steering wheel, and/or in order to temporarily contract the intermediate shaft so as to enable the universal joint to fit and fasten with the pinion shaft that engages with the rack shaft of the steering gear when the universal joint is joined to the pinion shaft, an expansion and contraction function is required.

For such purposes, the steering shaft and the intermediate shaft may comprise a telescopic shaft in which a male shaft and a female shaft are fitted to each other so as not to rotate and to slide freely. As for a structure of such a telescopic shaft, there is a structure where a male spline that is formed in the outer circumferential surface of the male shaft and a female spline that is formed in the inner circumferential surface of the female shaft are spline engaged, and there is also a structure that is described in such as JP2007191149 (A1) in which a male shaft and a female shaft are joined by fitting rolling elements between at least one pair of grooves in the axial direction that are formed in the outer circumferential surface of the male shaft and the inner circumferential surface of the female shaft.

### PRIOR ART DOCUMENTS

### Patent Literature

[Patent Literature 1] EP1344708 (A1)

[Patent Literature 2] JPH0872730 (A)

[Patent Literature 3] DE2459246 (A1)

[Patent Literature 4] JP2007191149 (A1)

### SUMMARY OF THE INVENTION

### Problem to be Solved by the Invention

When a hollow torque transmission member having a bellows portion is formed by bulge molding such as hydroforming molding, explosive molding (gas bulge molding), and rubber bulge molding, while sufficiently securing its thickness in the radial direction in order to join and fasten other members to the both end portions in the axial direction of the hollow torque transmission member to the both end portions so as to transmit torque therebetween, there is a possibility that the material cannot be sufficiently inflated radially outward and therefore the shape accuracy and the dimensional accuracy may be insufficient, or the pressure required for molding may be excessively large and therefore the manufacturing cost would increase.

Taking the situation described above into consideration, the objective of the present invention is to provide a hollow torque transmission member having a bellows portion in the middle section in the axial direction at low cost by bulge molding.

Further, when the intermediate shaft is constructed by a telescopic shaft, although the expansion and contraction function are sufficient that is required for adjusting the position of the steering wheel, preventing vibration of the wheels from being transmitted to the steering wheel, and/or connecting the intermediate shaft to the pinion shaft, there is a problem that the amount of collapse of the telescopic shaft is insufficient in order to sufficiently absorb the impact due to a primary collision by contraction of the intermediate shaft.

The present invention also aims to provide an intermediate shaft having expansion and contraction function and steering apparatus for an automobile comprising this intermediate shaft, the intermediate shaft having a structure to prevent a steering wheel from being displaced backwards so as not to be pushed up toward the body of the driver, even when the steering gear unit is displaced backward in a primary collision, specifically both in the case that so called a full lap collision occurs where the whole front portion of the vehicle collides to other automobiles and the like, and in the case that so called an offset collision occurs where a part of the front portion of the vehicle collides to other automobiles and the like.

### Means for Solving the Problems

The first aspect of the present invention relates to a hollow torque transmission member of steering apparatus for an automobile which is incorporated between a steering wheel and a steering gear unit in the transmission direction of the torque. The hollow torque transmission member of the present invention comprises a pair of connecting cylindrical portions and a bellows portion.

The pair of connecting cylindrical portions is connected to other members such as a shaft, a yoke, a connecting cylindrical portion of the yoke, and a connecting arm of the yoke so as to enable torque transmission.

The bellows portion is placed between the pair of connecting cylindrical portions.

When an automobile mounting the steering apparatus with the hollow torque transmission member of the present invention incorporated, is involved in a collision accident and an impact load is applied to the hollow torque transmission member, the hollow torque transmission member bends at the bellows portion.

Especially, the hollow torque transmission member of the present invention is formed so that the thickness of the bellows portion becomes smaller than the thickness of the pair of connecting cylindrical portions.

In the hollow torque transmission member of the present invention, it is preferable that the inner diameter of the pair of connecting cylindrical portions is smaller than the inner diameter of the portion (valley portion) where the inner diameter is the smallest in the bellows portion.

The hollow torque transmission member of the present invention can be applied to various members of the steering apparatus for an automobile such as an outer tube of the intermediate shaft, the intermediate shaft comprising the outer tube and an inner shaft having one end portion and the other end portion in the axial direction. When applying the hollow torque transmission member of the present invention to the outer tube, the other end portion in the axial direction of the inner shaft is fitted inside the cylindrical portion on one side in the axial direction of the pair of connecting cylindrical portions of the outer tube so as to enable torque transmission, that is, not to be able to rotate relatively, as well as to be able to be displaced from each other in the axial direction. In this case, for example, an intermediate shaft is formed by providing a female serration in the inner circumferential surface of the connecting cylindrical portion on the one side in the axial direction of the outer tube and engaging a male serration, which is provided in the outer circumferential surface of the inner shaft, to this female serration.

The second aspect of the present invention relates to a method for producing the hollow torque transmission member of the present invention. In the method for producing the hollow torque transmission member of the present invention, a thin thickness portion having a thickness in the radial direction that is smaller than that of other portions of a hollow material is formed all over the perimeter in the middle section in the axial direction of the hollow material, and expanding the thin thickness portion radially outward by bulge molding, for example by hydroforming molding, so as to mold the bellows portion.

In the method for producing the hollow torque transmission member of the present invention, for example, the inner diameter of the thin thickness portion is made larger than the inner diameter of a portion that deviates in the axial direction from the thin thickness portion of the material. In order to do this, for example, the thin thickness portion is formed by performing a cutting process to the inner circumferential surface in the middle section in the axial direction of the material, or by performing a roll forming process to press and plastically deform the inner circumferential surface in the middle section in the axial direction of the material radially outward.

Alternatively, the outer diameter of the thin thickness portion is made larger than the outer diameter of the portion that deviates to one side in the axial direction from the thin thickness portion of the material, and is made smaller than the outer diameter of the portion that deviates to other side in the axial direction from the thin thickness portion of the material. In order to do this, for example, the thin thickness portion is formed by performing a cutting process to the outer circumferential surface in the middle section in the axial direction of the material, or by performing a roll forming process to press and plastically deform the inner circumferential surface in the middle section in the axial direction of the material radially inward.

In the method for producing the hollow torque transmission member of the present invention, when forming the thin thickness portion, it is preferable to form a pair of taper portions on both end portions in the axial direction of the thin thickness portion, where the thickness becomes larger towards the direction away from each other in the axial direction.

Further, it is preferable to form the material with a small diameter portion on one side in the axial direction and a large diameter portion on the other side in the axial direction and to form the thin thickness portion in the large diameter portion.

When producing a hollow torque transmission member having a female serration in the inner circumferential surface in the connecting cylindrical portion of one side in the axial direction such as the outer tube from a hollow material having a small diameter portion of one side in the axial direction and a large diameter portion of the other side in the axial direction, it is preferable to form the female serration in the inner circumferential surface of the small diameter portion of the material after forming the bellows portion in the middle section in the axial direction of the material by performing a bulge molding such as a hydroforming molding to the material.

The third aspect of the present invention relates to an intermediate shaft comprising a front end portion that is connected to an input shaft of the steering gear unit of the steering apparatus for an automobile or to which a pinion gear of the steering gear unit is formed, and a rear end portion that is connected via a universal joint to a steering shaft of the steering apparatus for an automobile, the steering shaft rotatably supported to a steering column supported by the vehicle and having a rear end portion to which a steering wheel can be supported and fixed.

The intermediate shaft of the present invention comprises an outer tube located on one side in the axial direction and an inner shaft. The outer tube comprises a pair of connecting cylindrical portions and a bellows portion that is located between the pair of connecting cylindrical portions. The inner shaft comprises one end portion and the other end portion in the axial direction, the other end portion fitted inside a connecting cylindrical portion on one side in the axial direction of the pair of connecting cylindrical portions so as to enable torque transmission and to be relatively displaceable in the axial direction.

Alternatively, the intermediate shaft of the present invention comprises a collapse portion located on one side in the axial direction and a telescopic shaft portion located on the other side in the axial direction. The collapse portion comprises an outer tube and an inner shaft. The outer tube comprises a pair of connecting cylindrical portions and a bellows portion that is located between the pair of connecting cylindrical portions. The inner shaft comprising one end portion and the other end portion in the axial direction, the other end portion fitted inside a connecting cylindrical portion on one side in the axial direction of the pair of connecting cylindrical portions so as to enable torque transmission and to be relatively displaceable in the axial direction. The telescopic shaft portion comprises a male shaft and a female shaft fitted outside the male shaft so as to enable torque transmission and to be slidably, either end portion of the male shaft or the female shaft connected to a connecting cylindrical portion on the other side in the axial direction of the pair of connecting cylindrical portions or to the one end portion in the axial direction of the inner shaft so as to enable torque transmission.

The fourth aspect of the present invention relates to steering apparatus for an automobile. The steering apparatus for an automobile of the present invention comprises a steering shaft and an intermediate shaft that is arranged between the steering shaft and a steering gear unit. The steering shaft is rotatably supported to a steering column supported by the vehicle and has a rear end portion to which a steering wheel can be supported and fixed. The intermediate shaft comprises a front end portion that is connected to an input shaft of the steering gear unit or to which a pinion gear of the steering gear unit is formed, and a rear end portion that is connected via a universal joint to the steering shaft. In the steering apparatus for an automobile of the present invention, the intermediate shaft comprises at least an outer tube and an inner shaft. The outer tube comprises a pair of connecting cylindrical portions and a bellows portion that is located between the pair of connecting cylindrical portions. The inner shaft comprises one end portion and the other end portion in the axial direction, the other end portion fitted inside a connecting cylindrical portion on one side in the axial direction of the pair of connecting cylindrical portions so as to enable torque transmission and to be relatively displaceable in the axial direction.

In the steering apparatus for an automobile of the present invention, it is preferable that the intermediate shaft comprises a collapse portion located on one side in the axial direction of the intermediate shaft and having an outer tube and an inner shaft, and a telescopic shaft portion located on the other side. The outer tube comprises a pair of connecting cylindrical portions and a bellows portion that is located between the pair of connecting cylindrical portions. The inner shaft comprises one end portion and the other end portion in the axial direction, the other end portion fitted inside a connecting cylindrical portion on one side in the axial direction of the pair of connecting cylindrical portions so as to enable torque transmission and to be relatively displaceable in the axial direction. The telescopic shaft portion comprises a male shaft and a female shaft fitted outside the male shaft so as to enable torque transmission and to be slidably, either end portion of the male shaft or the female shaft connected to a connecting cylindrical portion on the other side in the axial direction of the pair of connecting cylindrical portions or to the one end portion in the axial direction of the inner shaft so as to enable torque transmission.

### Effect of the Invention

The present invention enables to provide a hollow torque transmission member having a bellows portion on the middle section in the axial direction at low cost by hydroforming molding.

Further, by applying the hollow torque transmission member of the present invention to an intermediate shaft or an outer tube of the collapse portion of the intermediate shaft, it is possible to provide a structure of the steering apparatus for an automobile to prevent a steering wheel from being displaced backwards so as not to be pushed up toward the body of the driver, even when the steering gear unit is displaced backward in a primary collision, specifically both in the case that a so called full lap collision occurs where the whole front portion of the vehicle collides to other automobile or the like, or in the case that a so called offset collision occurs where a part of the front portion of the vehicle collides to other automobile or the like.

### BRIEF DESCRIPTION OF THE DRAWINGS

FIG. 1(A) through FIG. 1(E) are cross-sectional views of the outer tube of the first example of an embodiment of the present invention illustrating an example of its manufacturing process shown in process orders.

FIG. 2 is a perspective view illustrating the outer tube shown in FIG. 1.

FIG. 3(A) is a cross-sectional view of an intermediate shaft in steady state that is composed of the outer tube and the inner shaft in relation to the first example of an embodiment of the present invention. FIG. 3(B) is a cross-sectional view illustrating the intermediate shaft shown in FIG. 3(A) in a state where a full lap collision is occurred.

FIG. 4 is a side view of the intermediate shaft shown in FIG. 3(A) in a state where an offset collision is occurred.

FIG. 5 is a conceptual diagram illustrating an example of a steering apparatus for an automobile mounted with the intermediate shaft shown in FIG. 3(A).

FIG. 6 is a cross-sectional view illustrating another two examples that correspond to the material having a thin thickness portion in the middle section in the axial direction shown in FIG. 1(C).

FIG. 7(A) is a side view of the intermediate shaft of the second example of an embodiment of the present invention. FIG. 7(B) is a cross-sectional view of the intermediate shaft of the second example of an embodiment of the present invention.

FIG. 8 is a side view of an example of a steering apparatus for an automobile to which the intermediate shaft shown in FIG. 7(A) and FIG. 7(B) is mounted.

FIG. 9 is a perspective view of an example of a steering apparatus for an automobile to which the intermediate shaft shown in FIG. 7(A) and FIG. 7(B) is mounted.

FIG. 10(A) is a side view illustrating a collapse portion of the steering apparatus for an automobile of the second example of an embodiment of the present invention in a normal state. FIG. 1(B) is a cross-sectional view of a collapse portion thereof in a normal state.

FIG. 11(A) is a side view of the collapse portion of the steering apparatus for an automobile of the second example of an embodiment of the present invention shown in a state where a full lap collision is occurred, and FIG. 11(B) is a cross-sectional view of the collapse portion in this state.

FIG. 12 is a side view of the collapse portion of the steering apparatus for an automobile of the second example of an embodiment of the present invention shown in a state where an offset collision is occurred.

### MODES FOR CARRYING OUT THE INVENTION

### First Example

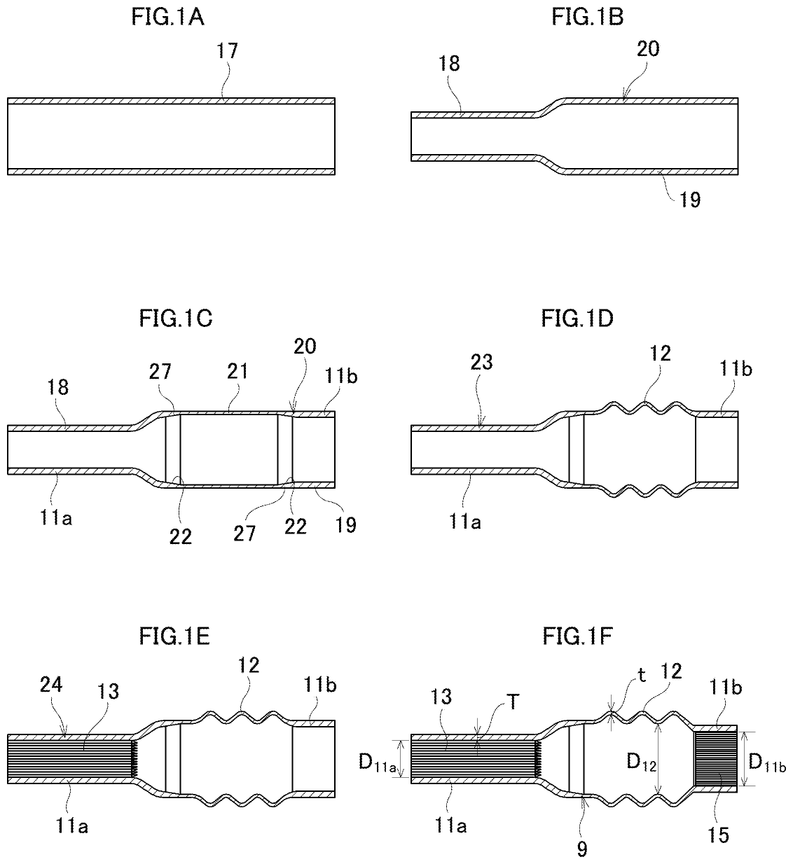

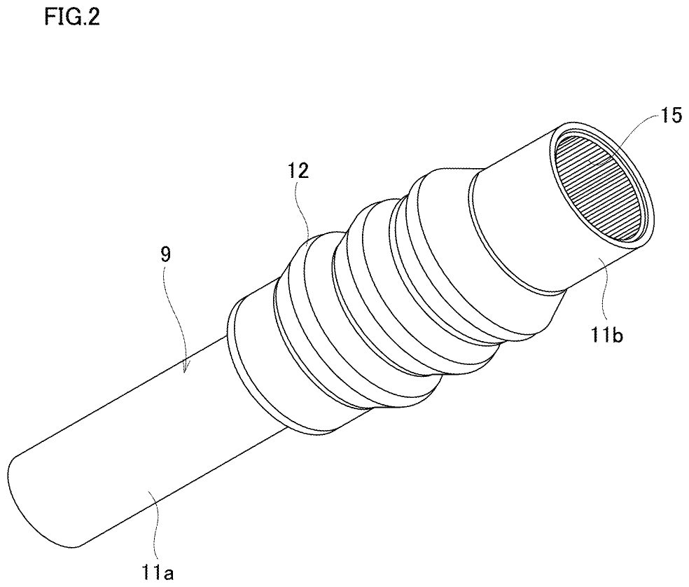

The first example of an embodiment of the present invention is explained with reference to FIG. 1(A) through FIG. 5. The present example is an example in which the present invention is applied to the outer tube 9 of the intermediate shaft 7 and the manufacturing method thereof.

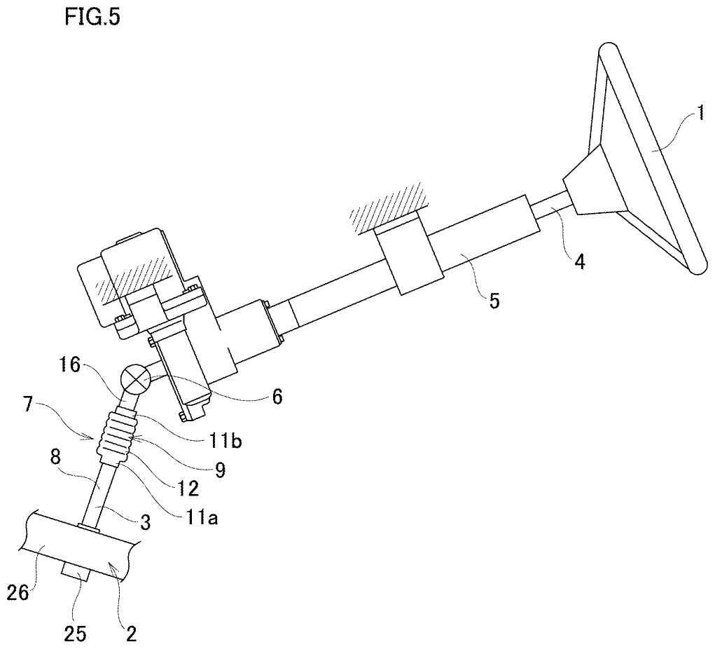

As illustrated in FIG. 5, the steering apparatus of an automobile is formed so as to transmit the rotation of the steering wheel 1 to the input shaft 3 of the steering gear unit 2 and apply a steering angle to the front wheels by pushing and pulling a pair of left and right tie rods with the rotation of the input shaft 3. The steering wheel 1 is supported and fixed to the rear end portion of the steering shaft 4. The steering shaft 4 is rotatably supported to the steering column 5 in a state where the steering shaft 4 is inserted into the cylindrical steering column 5 in the axial direction. The front end portion of the steering shaft 4 is connected to the rear end portion of the intermediate shaft 7 via a universal joint 6.

The intermediate shaft 7 comprises an outer tube 9 located on the rear side which is a hollow torque transmission member and an inner shaft 8 located on the front side which corresponds to other members, and is formed so as to be able to contracts its full length only when a large impact load is applied in the axial direction.

In the outer circumferential surface of the latter half portion of the inner shaft 8, a male serration 10 is formed over the axial direction. In the present example, the inner shaft 8 of the intermediate shaft 7 is formed to be integrated with the input shaft 3 of the steering gear unit 2. In this case, a pinion gear 25 is formed in the front end portion of the inner shaft 8 (input shaft 3), and the pinion gear 25 meshes with the rack teeth provided on the side surface of the rack shaft 26 of the steering gear unit 2. Alternatively, it is possible to employ a structure where the inner shaft 8 is formed separately from the input shaft 3 so that the front end portion of the inner shaft 8 is connected to the rear end portion of the input shaft 3 via a universal joint so as to enable torque transmission.

The outer tube 9 has a hollow cylindrical shape, and comprises a pair of connecting cylindrical portions 11a and 11b and a bellows portion 12 located between the pair of connecting cylindrical portions 11a and 11b.

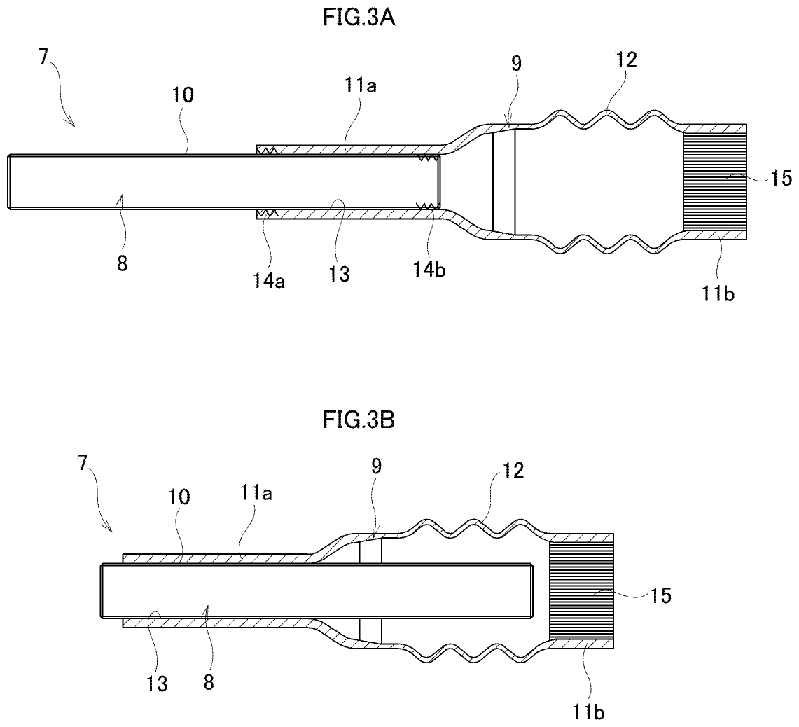

A front side female serration 13 is provided in the inner circumferential surface of the connecting cylindrical portion 11a on one side in the axial direction (front side, left side in FIG. 1(A) through FIG. 4) of the pair of connecting cylindrical portion 11a, 11b. The front side female serration 13 and the other half portion (latter half portion) in the axial direction of the male serration 10 of the inner shaft 8 are engaged as a serration engagement. Further, in the present example, the fitting portion between the outer tube 9 and the inner shaft 8 is constructed by so called elliptical fitting. That is, plastic deformation parts 14a, 14b of which the cross-sectional shape is an oval shape, are formed respectively on one end portion in the axial direction of the connecting cylindrical portion 11a on the one side in the axial direction of the outer tube 9 and the other end portion in the axial direction of the inner shaft 8. Here, in FIG. 3(A), wavy lines are respectively provided for the formation ranges of the plastic deformation parts 14a, 14b. Such plastic deformation parts 14a, 14b become a resistant when the outer tube 9 and the inner shaft 8 are relatively displaced in the axial direction. Due to such a structure, the connecting cylindrical portion 11a on the one side in the axial direction of the outer tube 9 and the other end portion in the axial direction of the inner shaft 8 are connected (fitted) so as to enable torque transmission, that is, so as not to be relatively rotatable against each other, as well as to be relatively displaceable in the axial direction only when a large impact load is applied in the axial direction. In the present example, the shock absorption capacity is improved when the intermediate shaft 7 contracts in the axial direction by elongating the length in the axial direction of the connecting cylindrical portion 11a on the one side in the axial direction so as to be sufficiently longer (about 2.5 times to 3.5 times, preferably about 3 times) than the length in the axial direction of the connecting cylindrical portion 11b on the other side in the axial direction.

The plastic deformation parts 14a, 14b are formed by processes such as shown below. First, the other end portion in the axial direction of the inner shaft 8 is slightly inserted to the one end portion in the axial direction of the outer tube 9. That is, the one end portion in the axial direction of the connecting cylindrical portion 11a on the one side in the axial direction and the other end portion in the axial direction of the inner shaft 8 are engaged. Then, the one end portion in the axial direction of the connecting cylindrical portion 11a on the one side in the axial direction is crushed with a tool from the outside in the radial direction so as to plastically deform the inner circumferential surface of the one end portion in the axial direction of the connecting cylindrical portion 11a on the one side in the axial direction and the outer circumferential surface of the other end portion in the axial direction of the inner shaft 8 to have an oval cross-section shape and form plastic deformation parts 14a, 14b in the concerned portions. After that, the outer tube 9 and the inner shaft 8 are relatively displaced in the axial direction until the full length of the intermediate shaft 7 becomes a predetermined length in the axial direction in a normal state of use. By doing this, the plastic deformation part 14a of the outer tube 9 and the plastic deformation part 14b of the inner shaft 8 are located separately in the axial direction.

A rear side female serration 15 is provided in the inner circumferential surface of the connecting cylindrical portion 11b on the other side in the axial direction (rear side, right side in FIG. 1(A) to FIG. 4) of the pair of connecting cylindrical portions 11a, 11b. A male serration that is provided on an outer circumferential surface in one end portion (front end portion) in the axial direction of a transmission shaft 16, that is joined and fastened to a yoke of the universal joint 6, is serration-engaged to the rear side female serration 15 to connect and fix the transmission shaft 16 to the connecting cylindrical portion 11b on the other side in the axial direction so as to enable torque transmission. However, as an alternative of the serration engagement or in addition to the serration engagement, it is also possible to connect the connecting cylindrical portion 11b on the other side in the axial direction of the outer tube 9 with the other end portion in the axial direction of the transmission shaft 16 by welding and the like so as to enable torque transmission. In either case, the connecting cylindrical portion 11b on the other side in the axial direction and the transmission shaft 16 are connected so as not to be relatively displaced in the axial direction.

In the present example, the rear side female serration 15 is provided in the inner circumferential surface of the connecting cylindrical portion 11b on the other side in the axial direction, however, when connecting the connecting cylindrical portion 11b to other member having a female serration provided in the inner circumferential surface of one end portion in the axial direction thereof, it is also possible to provide a rear side male serration on the outer circumferential surface of the connecting cylindrical portion 11b on the other side in the axial direction instead of this rear side female serration 15.

The bellows portion 12 is a portion which absorbs an impact load by plastically deforming to bend when an offset collision occurs, and it has a torsional strength that does not deform depends on the load in the torsion direction that is applied based on such as the operation of the steering wheel 1 by a driver in a normal state. The bellows portion 12 is constructed by alternatively placing a plurality of mountain portions having a large diameter and valley portions having a small diameter in the axial direction. In the present example, the shapes of the cross section of the top portions of the mountain portions and the bottom portions of the valley portions are arc shapes respectively.

In the outer tube 9 of the present example, the inner diameter D_{11b} (groove bottom diameter of the rear side female serration 15) of the connecting cylindrical portion 11b on the other side in the axial direction is smaller than the inner diameter D₁₂ of the portion (valley portion) where the inner diameter is the smallest of the bellows portion 12, and is larger than the inner diameter D₁₁ₐ (groove bottom diameter of the front side female serration 13) of the connecting cylindrical portion 11a on the one side in the axial direction (D₁₁ₐ<D_{11b}<D₁₂). However, in the present invention, provided that the inner diameter D₁₁ₐ of the connecting cylindrical portion 11a on the one side in the axial direction is smaller than the inner diameter D₁₂ of the portion (valley portion) where the inner diameter is the smallest of the bellows portion 12, it is also possible to employ a structure where the inner diameter D₁₁ₐ is made to be the same as the inner diameter D_{11b} of the connecting cylindrical portion 11b on the other side in the axial direction (D₁₁ₐ=D_{11b}<D₁₂), or a structure where the inner diameter D₁₁ₐ is larger than this inner diameter D_{11b} (D_{11b}<D₁₁ₐ<D₁₂).

Further, the thickness t of the bellows portion 12 is smaller than the thickness T of other portion (portion where deviates in the axial direction from the bellows portion 12) (t<T). Specifically, the thickness t of the bellows portion 12 is regulated to be within a range of 1/5 to 4/5 of the thickness T of the other portion, preferably within a range of 1/3 to 2/3, more particularly within a range of 1/3 to 1/2.

When a so called full lap collision in which the whole front portion of the vehicle collides to other automobile or the like occurs while an automobile in which the steering apparatus comprising the intermediate shaft 7 of the present example is mounted is driving, the whole steering gear unit 2 is strongly pushed backwards. As a result, an impact load in the axial direction is applied to the inner shaft 8 (input shaft 3) from the front side to the rear side. When the impact load in the axial direction is applied to the inner shaft 8, the inner shaft 8 is displaced backwards with respect to the outer tube 9, from the state illustrated in FIG. 3(A) to the state illustrated in FIG. 3(B), and the intermediate shaft 7 contracts the full length while absorbing an impact load. Due to this, it is prevented that the steering wheel 1 is displaced backwards and pushed towards the body of the driver. Here, when such a full lap collision occurs, in order for the inner shaft 8 and the outer tube 9 to be able to be relatively displaced before the bellows portion 12 crushes in the axial direction, the degree of stiffness and the degree of bond strength between the inner shaft 8 and the connecting cylindrical portion 11a on the one side in the axial direction are adjusted beforehand.

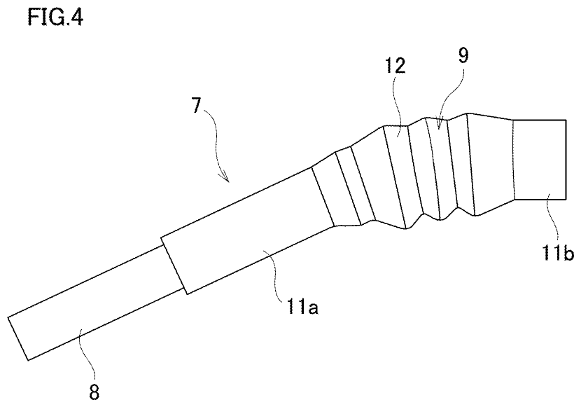

On the other hand, in a case where a so called offset collision in which a part of the front portion of a vehicle collides (biased in the width direction) to other automobile and the like occurs and the intermediate shaft 7 cannot contract in the axial direction as the engine room is deformed, as illustrated in FIG. 4, the outer tube 9 bends at the bellows portion 12 based on an impact load due to the collision. Due to this, an impact load is absorbed, and the bent intermediate shaft 7 is stored in a gap that exists between peripheral parts so as to be prevented to be displaced backwards. Therefore, even when an offset collision occurs, as in the case of the full set collision, it is prevented that the steering wheel 1 is displaced backwards and pushed towards the body of the driver. Here, when such an offset collision occurs, there may be a case where the inner shaft 8 and the outer tube 9 are not relatively displaced in the axial direction.

The following is an explanation regarding the manufacturing process of the outer tube 9 of the intermediate shaft 7 of the present example with reference to FIG. 1.

First, as illustrated in FIG. 1(A), a cylindrical preliminary material 17 is obtained by cutting a metal pipe, which is selected from iron-based alloys such as carbon steel for machine structure (STKM), light alloys such as aluminum alloy, or the like, into a predetermined length.

Then, as illustrated in FIG. 1(B), a stepped cylindrical material 20 comprising a small diameter portion 18 on one side in the axial direction thereof and a large diameter portion 19 on the other side in the axial direction is obtained by performing a drawing process on one half in the axial direction of the preliminary material 17. Here, the connecting portion between the large diameter portion 19 and the small diameter portion 18 is formed so as to be tapered where the outer diameter becomes larger toward the other side in the axial direction.

Then, as illustrated in FIG. 1 (C), a thin thickness portion 21 having a smaller thickness in the radial direction than other portion (the small diameter portion 18 and a portion of the large diameter portion 19 which deviates in the axial direction from the thin thickness portion 21) is provided by performing a cutting process on the inner circumferential surface of a portion near one end in the axial direction of the large diameter portion 19 of the material 20. In this state, the inner diameter of the thin thickness portion 21 is larger than the other portion, that is, the inner diameter of a portion which deviates in the axial direction from the thin thickness portion 21 of the material 20. At both end portions in the axial direction of the inner circumferential surface of the thin thickness portion 21, a pair of sloped surfaces 22 having a conical concaved surface shape that inclines in a direction in which the inner diameter becomes smaller (the thickness in the radial direction becomes larger) towards the direction away from each other is provided so as to provide a pair of taper portions 27 in which the thickness becomes larger toward the direction away from each other in the axial direction. Due to this, no step surface which faces to the axial direction exists between the inner circumferential surface of the thin thickness portion 21 and the inner circumferential surface of a portion that is adjacent to this thin thickness portion 21 in the axial direction, that is, concentration of stress on both ends in the axial direction of the thin thickness portion 21 is prevented in the next hydroforming molding by making the inner diameter of the material does not suddenly change in the axial direction. Here, in the illustrated example, the thickness t in the radial direction of the thin thickness portion 21 is made to be constant in the axial direction except for the pair of taper portions 27. However, it is also possible to change the thickness in the radial direction of the thin thickness portion 21 with respect to the axial direction. For example, it is possible to make the thickness in the radial direction of a portion of the thin thickness portion 21 which becomes a mountain portion of the bellows portion 12 smaller than the thickness in the radial direction of a portion of the thin thickness portion 21 which becomes a valley portion. Alternatively, it is also possible to form the thin thickness portion 21 only in a portion of the material 20 which becomes a mountain portion of the bellows portion 12.

Further, as illustrated in FIG. 1(D), the first intermediate material 23 is obtained by performing a hydroforming molding (bulge molding) to the material 20. That is, by applying a fluid pressure (water pressure) to the inner circumferential surface of the material 20 and plastically deforming the thin thickness portion 21 of the large diameter portion 19 of the material 20 so as to be expanded radially outward, the bellows portion 12 is molded and a portion that is adjacent to the other side in the axial direction of the thin thickness portion 21 is made to be the connecting cylindrical portion 11b on the other side in the axial direction. In the method for molding the first intermediate material 23 with a hydroforming method, for example, the material 20 is set in a die having an inner surface shape that matches the outer surface shape of the first intermediate material 23 that is formed by diameter expansion, and the openings on both sides in the axial direction of the material 20 are closed and a high fluid pressure is applied into the material 20. Due to the load of this fluid pressure, the thin thickness portion 21 of the material 20 is expanded outward in the radial direction until it closely contacts the inner surface of the cavity of the die so as to mold the first intermediate material 23. Therefore, the length in the axial direction of the first intermediate material 23 becomes smaller than the length in the axial direction of the material 20.

Then, as illustrated in FIG. 1(E), of the first intermediate material 23, a front side female serration 13 is formed on the inner circumferential surface of the connecting cylindrical portion 11a on the one side in the axial direction (small diameter portion 18) by a broaching process, swaging process, or the like to obtain the second intermediate material 24. When forming the front side female serration 13 by a broaching process, a cutting tool (broach) is inserted on the inner diameter side of the first intermediate material 23 from the other side opening in the axial direction of the first intermediate material 23 in a state where one end surface in the axial direction of the first intermediate material 23 is abutted to a step of a cradle and the inner circumferential surface of the connecting cylindrical portion 11a on the one side in the axial direction is cut. After that, the cutting tool is pulled out from the opening on the one side in the axial direction of the first intermediate material 23.

Lastly, as illustrated in FIG. 1(F), a rear side female serration 15 is formed on the inner circumferential surface of the connecting cylindrical portion 11b on the other side in the axial direction of the second intermediate material 24 by a swaging process or the like to obtain an outer tube 9. When forming the rear side female serration 15 by the swaging process, the inner diameter of the connecting cylindrical portion 11b on the other side in the axial direction after processing is smaller than the inner diameter thereof before processing. However, the rear side female serration 15 can also be formed by a broaching process. In this case, after pressing the tip end portion of the cutting tool from the other side opening in the axial direction of the second intermediate material 24, the cutting tool is displaced toward the other direction in the axial direction to pull out the tip end portion of this cutting tool from the inner diameter side of the connecting cylindrical portion 11b on the other side in the axial direction. In this case, when pressing the tip end portion of the cutting tool to the inside diameter side of the connecting cylindrical portion 11b on the other side in the axial direction, it is required to suppress the module of the rear side female serration 15 to be small so as to prevent a large force apply to the bellow portion 12 to the extent that this bellows portion 12 plastically deforms.

In the present example, it is possible to obtain the outer tube 9 having the bellows portion 12 in the middle section in the axial direction at low cost by hydroforming molding. That is, a thin thickness portion 21 having a smaller thickness in the radial direction than other portion is provided in the middle section in the axial direction of the material 20, where the bellows portion 12 is to be formed, and the bellow portion 12 is formed by expanding this thin thickness portion 21 outward in the radial direction. Therefore, in order to secure the bond strength between the inner shaft 8 and the transmission shaft 16 as well as to form the front side female serration 13 and the rear side female serration 15, even when the thickness in the radial direction of the connecting cylindrical portion 11a, 11b provided on both end portions in the axial direction is sufficiently secured, it is possible to mass-produce the outer tube 9 having the bellows portion 12 stably at low cost by hydroforming molding without making the fluid pressure (water pressure) excessively large. On the other hand, if the outer tube having the bellows portion in the middle section in the axial direction is formed by performing hydroforming molding to a material in which the thickness in the radial direction is constant over the axial direction, it becomes impossible to expand the material outward in the radial direction so that the shape accuracy and the dimensional accuracy may become insufficient, and there is a possibility that the fluid pressure required for molding becomes excessively large and the manufacturing cost would increase.

Further, in the present example, the whole of the outer tube 9 is integrally formed by performing hydroforming molding to the stepped cylindrical material 20. On the other hand, if the bellows portion and a portion for connecting with other member are produced as separate parts, it requires much time and work for connecting these parts by welding or the like. In the present example, the cost for producing the outer tube 9 can be reduced as it is possible to omit time and work for managing such parts and connecting them by welding or the like. However, when the hollow torque transmission member of the present invention is applied to the yoke of the universal joint, it is possible to join and fasten a connecting cylinder and a connecting arm of the yoke to both end portions in the axial direction of the hollow torque transmission member by welding or caulking.

In the present example, by performing a cutting process on the inner circumferential surface of a portion near one end in the axial direction of the large diameter portion 19 of the material 20, a thin thickness portion 21 is provided in this portion, and by expanding this thin thickness portion 21 outward in the radial direction by hydroforming molding so as to mold the bellow portion 12. Therefore, it is possible to make the thickness of the bellows portion 12 to be constant. That is, a metallic preliminary material (pipe material) 17 that becomes a raw material is produced to be cylindrical based on the outer diameter. Therefore, the thickness in the radial direction of the thin thickness portion 21 can be highly precisely regulated by cutting the inner circumferential surface of the material 20 that is obtained from the preliminary material 17, and the thickness of the bellows portion 12 after molding can be constant. Further, in comparison with a case where the outer circumferential surface of the material 20 is cut, it is possible for the molding property due to hydroforming molding to be favorable as well as to improve durability with respect to the steering torque by smoothening the outer circumferential surface of the bellows portion 12 after molding so as to suppress the stress concentration when the steering torque is applied.

Further, the metallic preliminary material 17 that becomes a raw material is produced to be cylindrical based on the outer diameter. Due to this, the preliminary material 17 and a hardened layer are formed on the outside in the radial direction of the outer diameter portion of the material 20. After the bellows portion 12 is formed, when the outer tube bends at the bellows portion 12 due to the occurrence of an offset collision or the like, the outside portion (top of the mountain portion) of the bellows portion 12 having a maximum diameter becomes a stress concentration portion. The hardened layer exists (remains) on the outer circumferential surface of the bellows portion 12 due to cutting the inner circumferential surface of the material 20, the strength of the bellows portion 12 can be secured and it is prevented that the bellows portion 12 breaks at the outside portion having the maximum diameter. From this point of view as well, there is an advantage to cutting the inner circumferential surface of the material 20.

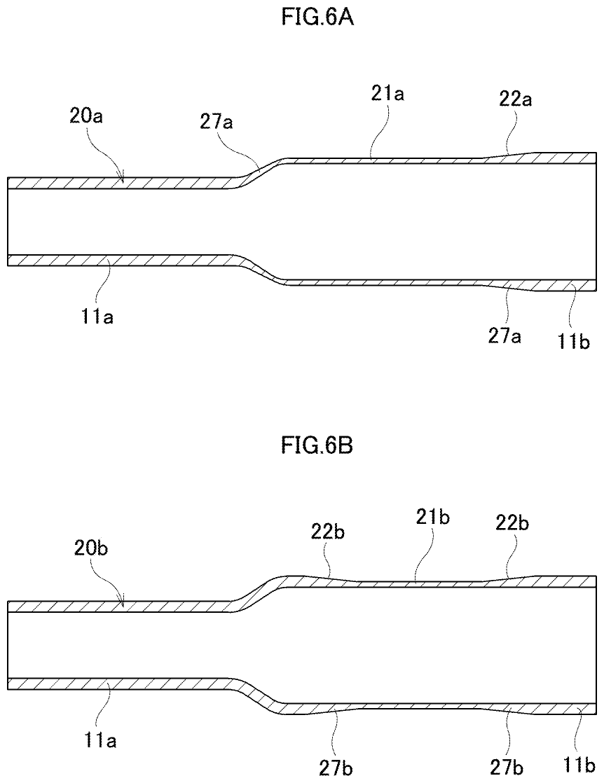

However, the outer tube having the bellows portion can be produced by performing hydroforming molding to the material 20a as illustrated in FIG. 6(A) or the material 20b as illustrated in FIG. 6(B). The material illustrated in FIG. 6(A) provides a thin thickness portion 21a from the continuous portion that is continuous with the small diameter portion 18 on one side in the axial direction and the large diameter portion 19 on the other side in the axial direction to the middle portion in the axial direction of the large diameter portion 19 on the other side in the axial direction. The outer diameter of this thin thickness portion is larger than the outer diameter of the connecting cylindrical portion 11a on the one side in the axial direction and smaller than the outer diameter of the connecting cylindrical portion 11b on the other side in the axial direction, and the thickness in the radial direction of the thin thickness portion 21a is smaller than the thickness in the radial direction of a pair of connecting cylindrical portion 11a, 11b. Such material 20a is provided with a sloped surface 22a, which has an outer diameter that becomes larger toward other side in the axial direction, on the outer circumferential surface on the other end portion in the axial direction of the thin thickness portion 21a, and the outer circumferential surface of the one end portion in the axial direction of the thin thickness portion 21a is made smoothly continuous with the outer circumferential surface of the connecting cylindrical portion 11a on the one side in the axial direction. Due to this, a pair of taper portions 27a, 27b, which have a thickness that becomes larger toward the direction away from each other in the axial direction, is provided on both end portions in the axial direction of the thin thickness portion 21a, and it is prevented that the stress concentrates on both end portions in the axial direction of the thin thickness portion 21a. Such thin thickness portion 21a can be formed, for example, by cutting the outer circumferential surface of the material 20a or pushing inward in the radial direction so as to cause plastic deformation thereof.

On the other hand, the material 20b illustrated in FIG. 6(B) is provided a thin thickness portion 21b in the middle section in the axial direction of the large diameter portion 19. In the material 20b as well, the outer diameter of the thin thickness portion 21b is larger than the outer diameter of the connecting cylindrical portion 11a on one side in the axial direction, and is smaller than the outer diameter of the connecting cylindrical portion 11b on the other side in the axial direction, and the thickness in the radial direction of the thin thickness portion 21b is smaller than the thickness in the radial direction of the pair of connecting cylindrical portion 11a, 11b. Further, a pair of taper portions 27b, 27b, which have a thickness that becomes larger towards the direction away from each other in the axial direction, are provided on both end portions in the axial direction of the thin thickness portion 21b. Therefore, a pair of sloped surface 22b, 22b, which have a conical convex surface shape that inclines to the direction where the outer diameter becomes larger towards the direction away from each other, are formed on both end portions in the axial direction of the outer circumferential surface of the thin thickness portion 21b. Due to such a structure, it is prevented that a stress concentrates on the both end portions in the axial direction of the thin thickness portion 21a when performing hydroforming molding. This thin thickness portion 21b as well can be formed by cutting the outer circumferential surface of the material 20b or pushing inward in the radial direction so as to cause plastic deformation thereof.

Here, the order of the processes for producing the outer tube 9 from the cylindrical preliminary material 17 can be switched, and the processes can be performed simultaneously as long as the bellows portion 12 is formed after forming the thin thickness portion 21 and do not contradict each other. For example, it is possible to obtain a stepped cylindrical material 20 by performing a drawing process to the cylindrical preliminary material 17 after performing a cutting process to the inner circumferential surface of the middle section in the axial direction of this cylindrical preliminary material 17. Further, the front side female serration 13 can also be formed by a swaging process on the inner circumferential surface of the connecting cylindrical portion 11a on one side in the axial direction after forming the rear side female serration 15 on the inner circumferential surface of the connecting cylindrical portion 11b on the other side in the axial direction.

Further, in the present example, although the outer tube 9 having a bellows portion 12 is produced by hydroforming molding, alternatively, it is also possible to obtain an outer tube 9 as similar to hydroforming molding by employing means such as explosive molding (gas bulge molding) and rubber bulge molding as bulge molding. Therefore, the method for producing the hollow torque transmission member of the present invention is not limited by the kinds of bulge molding for forming the bellows portion.

In the present example, the inner shaft 8 is located on the front side of the intermediate shaft 7 and the outer tube 9 is located on the rear side thereof, however, it is also possible that the outer tube 9 is located on the front side and the inner shaft 8 is located on the rear side. However, it is preferable that the outer tube 9 is located on the rear side from the point of view in which the bellows portion 12 is made to be easily deformed by enlarging the moment that applies to the bellows portion 12 of the outer tube 9.

In the present example, the fitting portion of the outer tube 9 and the inner shaft 8 is made to be so called elliptical fitting, and the outer tube 9 and the inner shaft 8 are made to be able to be relatively displaced in the axial direction only when a large impact load is applied in the axial direction. However, it is also possible to fit the outer tube and the inner tube so as to be able to be relatively displaced in the axial direction with light force. For example, the outer circumferential surface of the inner shaft is coated with a synthetic resin and further coated with grease and an end portion in the axial direction of this inner shaft can be fitted inside the connecting cylindrical portion on one side in the axial direction of the outer tube. Alternatively, an end portion in the axial direction of the inner shaft and the connecting cylindrical portion of one side in the axial direction of the outer tube can be fitted via rolling elements such as balls and rollers.

### Second Example

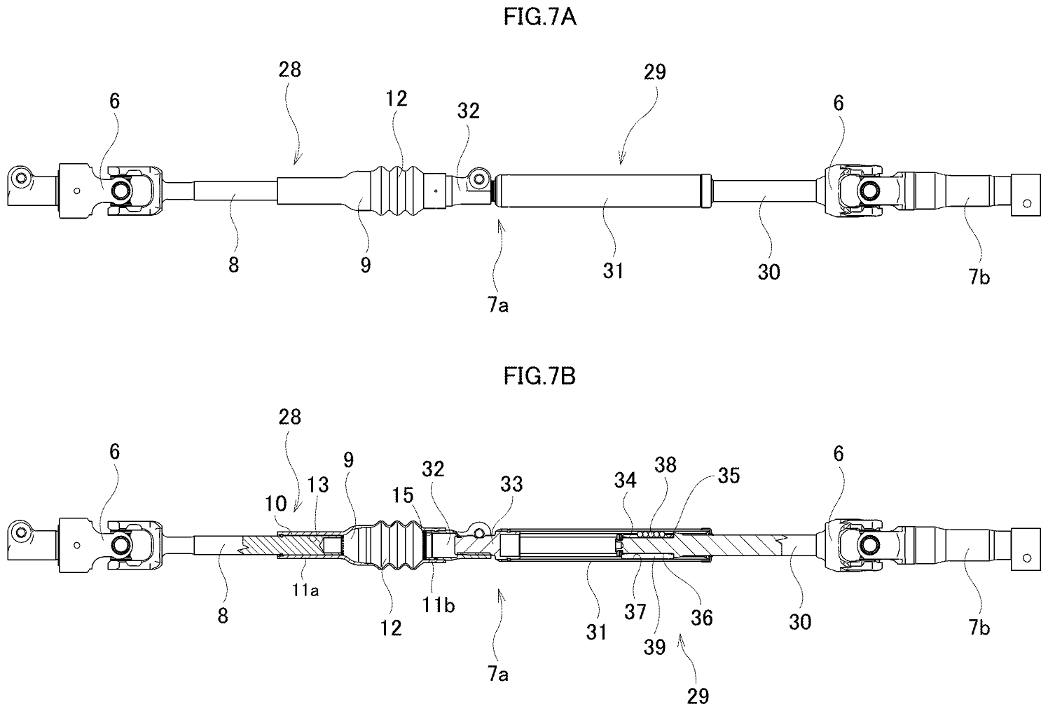

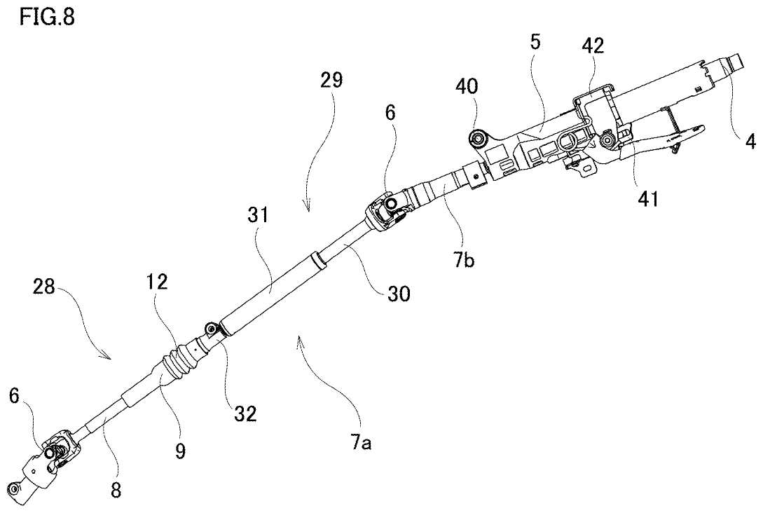

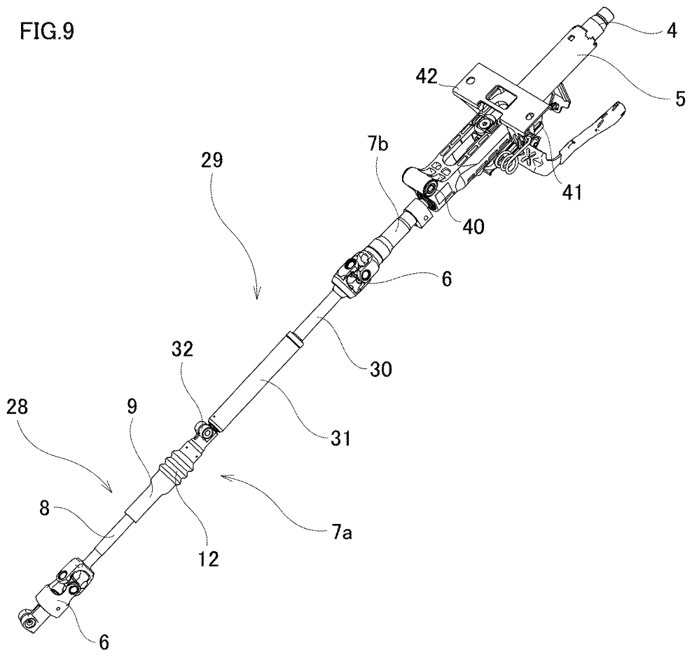

The following is an explanation regarding the second example of an embodiment of the present invention with reference to FIG. 7(A) to FIG. 12. The present example is an example in which the present invention is applied to an intermediate shaft, which comprises a collapse portion comprising an outer tube and an inner shaft, and a telescopic shaft portion comprising a male shaft and a female shaft that is fitted onto the male shaft so as to enable torque transmission and to slide freely, and steering apparatus for an automobile to which this intermediate shaft is mounted.

In the steering apparatus for an automobile of the present example, the intermediate shaft 7a comprises a front end portion and a rear end portion and is located between a steering shaft 4, which is rotatably supported to the steering column 5 supported by a vehicle and has a rear end portion to which a steering wheel 1 can be supported and fixed, and a steering gear unit 2 (see FIG. 5). The intermediate shaft 7a comprises a front end portion that can be connected to an input shaft of the steering gear unit 2 or to which a pinion gear 25 of the steering gear unit 2 is formed, and a rear end portion that is connected to the steering shaft 4 via a universal joint 6.

In the present example, the steering apparatus for an automobile comprises a tilt mechanism for adjusting the up-down position of the steering wheel 1 or a telescopic mechanism for adjusting the forward-backward position based on the physique and the driving position of a driver. In order to construct the tilt mechanism, the steering column 5 is supported to the vehicle so as to enable pivotally displacement centered about the pivot shaft 40 that is arranged in the width direction of the vehicle. Further, a displacement bracket 41 that is fixed to a portion near the rear end of the steering column 5 is supported to the support bracket 42 supported by the vehicle so as to be displaceable in the up-down direction and in the forward-backward direction of the vehicle. On the other hand, in order to construct the telescopic mechanism, the steering column 5 comprises an outer column and an inner column that are telescopically assembled so as to be capable of expansion and contraction of the steering column 5, and the steering shaft 4 comprises an outer shaft and an inner shaft that are telescopically assembled by spline engagement or the like so as to enable torque transmission and to be capable of expansion and contraction of the steering shaft 4. Such structure of a steering column unit is known, so detailed explanation is omitted.

The intermediate shaft 7a of the present example comprises a collapse portion 28 located on one side in the axial direction (front side in the forward-backward direction of the vehicle in the present example) and a telescopic shaft portion 29 located on the other side in the axial direction (rear side in the forward-backward direction of the vehicle of the present example). The collapse portion 28 comprises an outer tube 9 and an inner shaft 8. The outer tube 9 comprises a pair of connecting cylindrical portions 11a, 11b and a bellows portion 12 that is located between the pair of connecting cylindrical portions 11a, 11b. The inner shaft 8 comprising one end portion and the other end portion in the axial direction, the other end portion fitted inside a connecting cylindrical portion 11a on one side in the axial direction of the pair of connecting cylindrical portions 11a, 11b so as to enable torque transmission and to be relatively displaceable in the axial direction. The telescopic shaft portion 29 comprises a male shaft 30 and a female shaft 31 fitted outside the male shaft 30 so as to enable torque transmission and to be slidably, one end portion of the female shaft 31 connected to a connecting cylindrical portion 11b on the other side in the axial direction of the pair of connecting cylindrical portions 11a, 11b via a joint 32 so as to enable torque transmission.

In the present example, the rear end portion of the intermediate shaft 7a is connected to the front end portion of the steering shaft 4 so as to enable torque transmission via a universal joint 6 and another intermediate shaft 7b. However, it is also possible to connect the rear end portion of the intermediate shaft 7a to the front end portion of the steering shaft 4 only via the universal joint 6. Further, the front end portion of the intermediate shaft 7a is connected to the input shaft 3 of the steering gear unit 2 via a universal joint 6. Therefore, in the present example, a connecting cylinder of a yoke of the universal joint 6 is joined and fastened to one end portion in the axial direction of the inner shaft 8 of the collapse portion 28 by welding or the like. However, it is also possible to form the yoke of the joint 6 to be integrated on the one end portion in the axial direction of the inner shaft 8, or to form a pinion gear 25 of the steering gear unit 2 similar to the first example of an embodiment of the present invention.

The collapse portion 28 of the intermediate shaft 7a of the present example comprises a configuration that is similar to the intermediate shaft 7 of the first example of an embodiment. In the outer tube 9 of the present example as well, a front side female serration 13 is provided on the inner circumferential surface of the connecting cylindrical portion 11a on the one side in the axial direction of the pair of connecting cylindrical portion 11a, 11b. The collapse portion 28 is formed by engaging the front side female serration 13 and other half portion (latter half portion) in the axial direction of the male serration 10 of the inner shaft 8 with serration engagement. Further, in the present example as well, the fitting portion between the outer tube 9 and the inner shaft 8 is formed by so called elliptical fitting. In the present example as well, due to such a configuration, the connecting cylindrical portion 11a on the one side in the axial direction of the outer tube 9 and the other end portion in the axial direction of the inner shaft 8 are connected (fitted) so as to enable torque transmission, that is, so as to be impossible to rotate relatively against each other and to be able to be relatively displaced in the axial direction only when a large impact load is applied in the axial direction.

In the outer tube 9 of the present example as well, a rear side female serration 15 is provided on the inner circumferential surface of the connecting cylindrical portion 11b on the other side (rear side) in the axial direction. To the rear side female serration 15, a male serration that is provided on the outer circumferential surface of one end portion in the axial direction of a joint 32, which is for connecting the collapse portion 28 to the telescopic shaft portion 29, is engaged by serration engagement. However, alternatively or in addition to the serration engagement, it is also possible to connect the connecting cylindrical portion 11b on the other side in the axial direction of the outer tube 9 and the one end portion in the axial direction of the joint 32 by welding or the like. Further, in the present example as well, a rear side male serration is provided on the outer circumferential surface of the connecting cylindrical portion 11b of the outer tube 9 and a female serration is provided on the inner circumferential surface of the one end portion in the axial direction of the joint 32 so as to connect them by serration engagement.

In the present example as well, the bellows portion 12 is a portion which absorbs an impact load due to a collision by plastic deformation thereof so as to be bent when an offset collision occurs, and it has torsional strength not to be deformed depends on the load in the torsion direction applied based on the operation of the steering wheel 1 by a driver in a normal situation.

The configuration, function, and the method for producing the collapse portion 28 and the outer tube 9 comprising the bellows portion 12 is the same as that of the first example of an embodiment.

Besides from the collapse portion 28, the intermediate shaft 7a of the present example is characterized in comprising a telescopic shaft portion 29. The telescopic shaft portion 29 comprises a male shaft 30 and a female shaft 31 that are fitted so as to enable torque transmission, that is, so as to be impossible to relatively rotate against each other and to be able to slide freely. In the present invention, the configuration for achieving the functions of the telescopic shaft portion 29 is arbitrary, and known means besides spline engagement may be employed.

In the present example, the male shaft 30 is located on the other side in the axial direction (rear side, steering shaft side), and a connecting arm of the yoke of the universal joint 6 is connected to the other end portion in the axial direction of the male shaft 30 by welding or to be formed to be integrated. On the other hand, the female shaft 31 is located on the one side in the axial direction (front side, steering gear side), and a bonding shaft 33 is fitted and fixed inside the one end portion in the axial direction of the female shaft 31, and this bonding shaft 33 is fixed to the joint 32 so as to enable torque transmission, that is, so as to be impossible to relatively rotate against each other. Therefore, the collapse portion 28 and the telescopic shaft portion 29 are connected via the joint 32 so as to be impossible to relatively rotate against each other.

In the present example, as illustrated in FIG. 7(B), three pairs of arc-shaped grooves 34, 36 that are equally spaced by 120 degrees in the circumferential direction are extended and formed in the axial direction on the outer circumferential surface of the male shaft 30. On the inner circumferential surface of the corresponding female shaft 31 as well, three pairs of arc-shaped grooves 35, 37 that are equally spaced by 120 degrees in the circumferential direction are extended and formed. A plurality of balls (spherical rolling elements) are fitted between one groove 34 in the axial direction in each pair of the male shaft 30 and one groove 35 in the axial direction in each pair of the corresponding female shaft 31 via a leaf spring for preload (not shown). Here, in the present example, the leaf spring is located in one groove 34 in the axial direction in each pair of the male shaft 30. Therefore, the leaf spring as a whole is made not to be able to move in the circumferential direction due to the groove 34 in the axial direction when transmitting torque.

On the other hand, a needle roller (sliding body) 39 is fitted between the other groove 36 in the axial direction of the male shaft 30 and the other groove 37 in the axial direction of the corresponding female shaft 31 so as to slide freely.

When not transmitting torque, the leaf spring preloads the ball 38 and the needle roller 39 to a degree without rattling with respect to the female shaft 31. On the other hand, when transmitting torque, the leaf spring plastically deforms so as to work to circumferentially constrain the ball 38 between the male shaft 30 and the female shaft 31.

A groove in the circumferential direction is provided on one end portion in the axial direction of the male shaft 30. A stopper plate is fitted in this groove in the circumferential direction and the needle roller 39 is fixed in the axial direction.

In the telescopic shaft portion 29 structured as described above, when not transmitting torque, the ball 38 and the roller 39 are used for “rolling” and “sliding” respectively, and the ball 38 is preloaded by the leaf spring to a degree without rattling with respect to the female shaft 31, rattling between the male shaft 30 and the female shaft 31 is surely prevented and the male shaft 30 and the female shaft 31 are able to slide in the axial direction at a stable sliding load without rattling.

When transmitting torque, the needle roller 39 being interspersed between the male shaft 30 and the female shaft 31 plays a major role in torque transmission. For example, when torque is input from the male shaft 30, there is no rattling in the initial stage as a preload is applied from the leaf spring, and the leaf spring generates reaction force against torque so as to transmit the torque. When doing this, the torque transmission load among the male shaft 30, the leaf spring, the ball 38, and the female shaft 31 and the torque transmission load between the male shaft 30, the needle roller 39, and the female shaft 31 are in a state of balance so as to transmit overall torque.

When the torque further increases, as the gap in the rotation direction between the male shaft 30, the needle roller 39, and the female shaft 31 is set smaller than the gap between the male shaft 30, the leaf spring, the ball 38, and the female shaft 31, the needle roller 39 receives a strong reaction force compared to the ball 38 so that the needle roller 39 mainly transmits torque to the female shaft 31. Therefore, rattling in the rotational direction of the male shaft 30 and the female shaft 31 is surely prevented and torque is transmitted in a highly rigid state.

Further, when the steering torque is at a predetermined level or low, while the leaf spring demonstrates low rigidity characteristics by performing preload action, when the steering torque is at a predetermined level or more, the needle roller 39 engages in the circumferential direction with a pair of grooves 36, 37 in the axial direction and demonstrates high rigidity characteristics.

That is, when the steering torque is at a predetermined level or less, the leaf spring buffers and reduces unpleasant noise and vibration from the engine room due to the preload property. On the other hand, when the steering torque rises to a predetermined level or more, each of the needle rollers 39 engages in the circumferential direction with a pair of grooves 36, 37 in the axial direction so as to be able to transmit steering torque, and it is possible to obtain a feeling of sharp steering.

Therefore, the telescopic shaft portion 29 of the present example is equipped with torque transmission and sliding mechanisms and buffer mechanisms, and while effectively using space, reducing the number of parts, and reducing the manufacturing cost, it comprises two-step torsional stiffness characteristics.

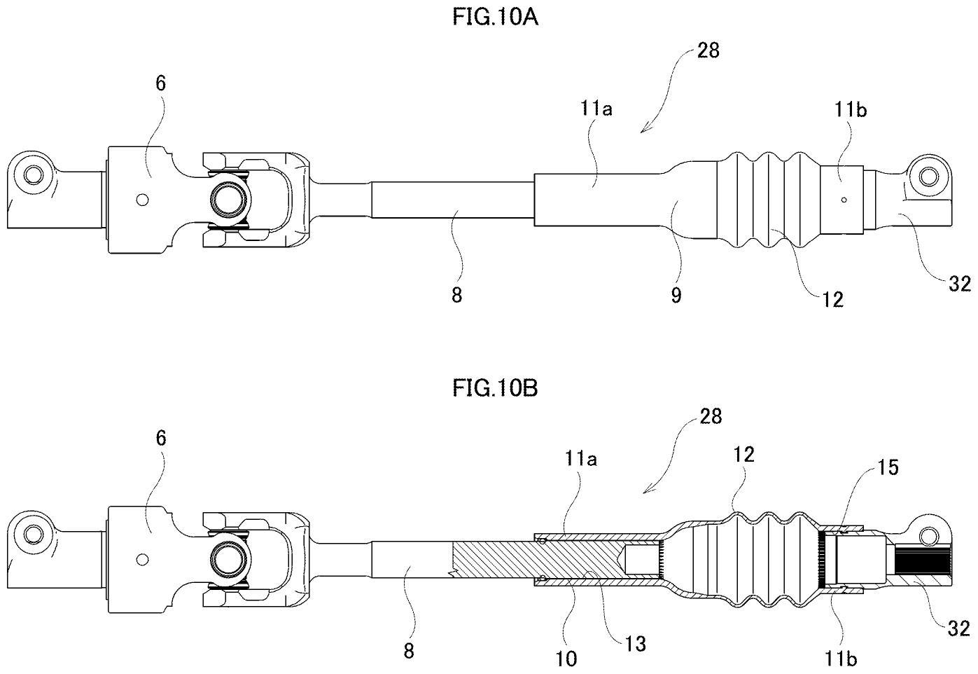

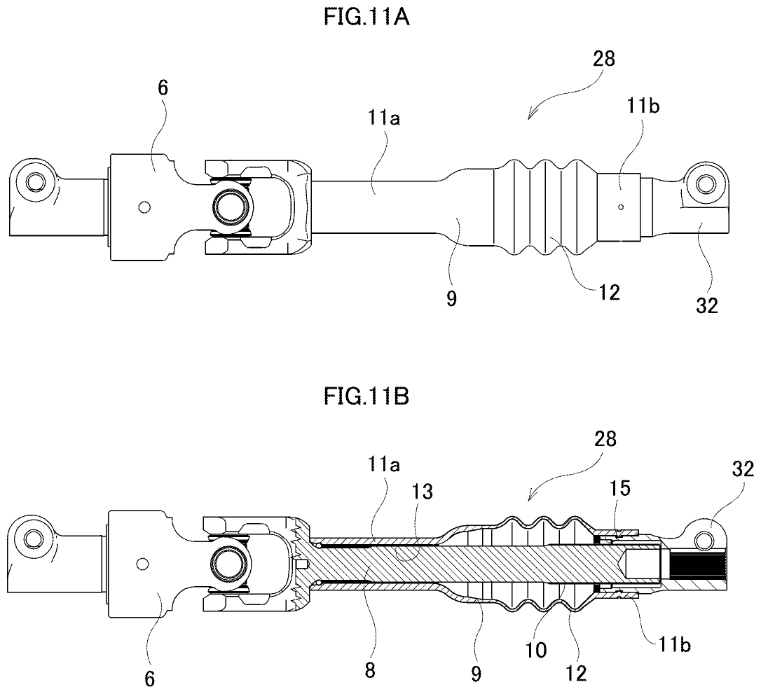

When a so called full lap collision in which the whole front portion of the vehicle collides to other automobile or the like occurs while driving an automobile in which a steering apparatus comprising the intermediate shaft 7a of the present example is mounted and an impact load in the axial direction is applied to the inner shaft 8 from the front side to the rear side, first the telescopic shaft portion 29 slides, then the female shaft 31 slides in the axial direction with respect to the male shaft 30. Further, the inner shaft 8 is displaced backward with respect to the outer tube 9 from the state illustrated in FIG. 10(A) and FIG. 10(B) to the state illustrated in FIG. 11(A) and FIG. 11(B), and the collapse portion 28 of the intermediate shaft 7a contracts its full length while absorbing an impact load. Due to this, it is prevented that the steering wheel 1 is displaced backwards and pushed towards the body of the driver. Here, in the present example as well, in order for the inner shaft 8 and the outer tube 9 to be able to initiate relative displacement before the bellows portion 12 crushed in the axial direction when a full lap collision occurs, the degree of stiffness of the bellows portion 12 and the degree of bond strength between the inner shaft 8 and the connecting cylindrical portion 11a on the one side in the axial direction is adjusted in advance.

In the intermediate shaft 7a of the present example, not only the telescopic shaft portion 29 contracts in the axial direction, but also the elliptical fitting between the outer tube 9 and the inner shaft 8 of the collapse portion 28 is released due to a large impact load, the inner shaft 8 is relatively displaced in the axial direction with respect to the outer tube 9 and the collapse portion 28 contracts in the axial direction so as to sufficiently secure a plenty amount of collapse of the intermediate shaft 7a. Especially, in the present example, a half portion on one end side in the axial direction of the joint 32 is formed to be cylindrical, and a large amount of collapse is secured as the inner shaft 8 can enter the inside in the radial direction of the connecting cylindrical portion 11b of the other side in the axial direction of the outer tube 9 and the half portion on the one end side in the axial direction of the joint 32.

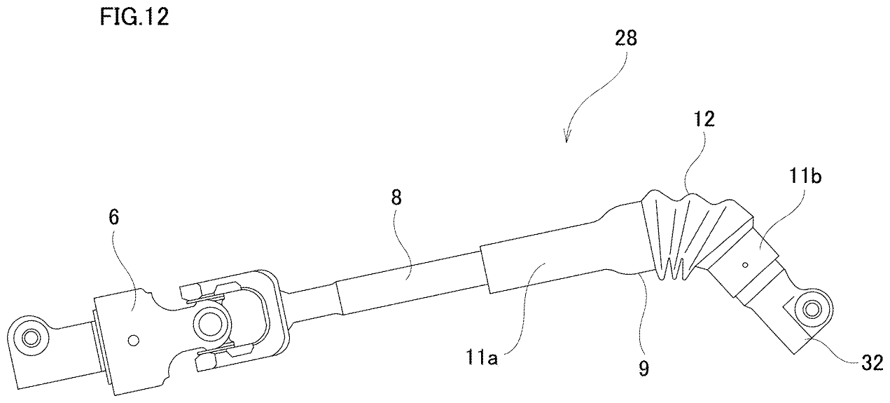

On the other hand, when a so called offset collision occurs and the intermediate shaft 7a seems not to be able to contracts in the axial direction, the outer tube 9 bends at the bellows portion 12 based on an impact load due to the collision as illustrated in FIG. 12. Due to this, the impact load is absorbed and the bent intermediate shaft 7a is stored in a gap that exists between peripheral parts so as to prevent backward displacement. Therefore, in the present example as well, even in an offset collision, as in the case of the full set collision, it is prevented that the steering wheel 1 is displaced backwards and pushed up towards the body of a driver. Here, when such an offset collision occurs, there may be a case where the inner shaft 8 and the outer tube 9 of the collapse portion 28 are not relatively displaced in the axial direction.

In the present example, the collapse portion 28 is located on one side in the axial direction (front side) of the intermediate shaft 7a, the outer tube 9 is located on the other side (rear side) in the axial direction, and the bellows portion 12 is located on other side in the axial direction than the connecting cylindrical portion 11a on the one side in the axial direction. That is, the bellows portion 12 is arranged near the center in the axial direction of the intermediate shaft 7a. Due to this, depending on the situation of the offset collision, even when the bending angle of the bellows portion 12 is small, it is possible to sufficiently secure an amount of evacuation of the intermediate shaft 7a. Further, when an offset collision occurs, actually, the bellows portion 12 bends after the telescopic shaft portion 29 contracts in the axial direction. Due to the contraction of the telescopic shaft portion 29 in the axial direction, the bellows portion 12 gets further closer to the center portion in the axial direction of the intermediate shaft 7a. Therefore, by such a configuration, or even if the bending angle of the bellows portion 12 is small, it is possible to secure a large amount of evacuation of the intermediate shaft 7a.

Here, the location of the intermediate shaft 7a is not limited to the location of the present example. It is also possible that the telescopic shaft portion 29 is located on one side in the axial direction (front side in the forward-backward direction of the vehicle) and the collapse portion 28 is located on the other side in the axial direction (rear side in the forward-backward direction of the vehicle). Further, the locations of the male shaft 30 and the female shaft 31 of the telescopic shaft portion 29 can be reversed in the axial direction. However, as for the collapse portion 28, it is preferred from the above point of view that the bellows portion 12 is located near the center in the axial direction of the intermediate shaft 7a. Therefore, when the collapse portion 28 is located on the other side in the axial direction, it is preferable that the outer tube 9 is located on one side in the axial direction (front side) and the inner shaft 8 is located on the other side in the axial direction (rear side).

### Explanation of the Reference Numbers

1 Steering Wheel

2 Steering Gear Unit

3 Input shaft

4 Steering shaft

5 Steering column

6 Universal joint

7, 7a, 7b Intermediate shaft

8 Inner shaft

9 Outer tube

10 Male serration

11a, 11b Connecting cylindrical portion

12 Bellows portion

13 Front side female serration

14a, 14b Plastic deformation part

15 Rear side female serration

16 Transmission shaft

17 Preliminary material

18 Small diameter portion

19 Large diameter portion

20, 20a, 20b Material

21, 21a, 21b Thin thickness portion

22, 22a, 22b Sloped surface

23 First intermediate material

24 Second intermediate material

25 Pinion gear

26 Rack shaft

27, 27a, 27b Taper portion

28 Collapse portion

29 Telescopic shaft portion

30 Male shaft

31 Female shaft

32 Joint

33 Bonding shaft

34 Groove in the axial direction

35 Groove in the axial direction

36 Groove in the axial direction

37 Groove in the axial direction

38 Ball (Rolling elements)

39 Needle roller

40 Pivot shaft

41 Displacement bracket

42 Support bracket

1-15. (canceled)

16. A method for producing a hollow torque transmission member comprising a pair of connecting cylindrical portions capable of being connected to other member so as to enable torque transmission and a bellows portion located between the pair of connecting cylindrical portions, the method comprising a step of:
forming a thin thickness portion all around a middle section in an axial direction of a hollow material by performing a cutting process on an inner circumferential surface of the middle section in the axial direction of the hollow material, the thin thickness portion having a thickness in a radial direction smaller than a thickness in the radial direction of the other portion that deviates in the axial direction from the thin thickness portion of the hollow material and an inner diameter larger than an inner diameter of the other portion, and molding the bellow portion by expanding the thin thickness portion outward in the radial direction by bulge molding.

17. The method for producing the hollow torque transmission member according to claim 16, wherein a small diameter portion is provided on the one side in the axial direction of the hollow material and a large diameter portion is provided on the other side in the axial direction, and the thin thickness portion is formed in the large diameter portion.

18. The method for producing the hollow torque transmission member according to claim 16, wherein, in a case that a female serration is formed on an inner circumferential surface of a connecting cylindrical portion on one side in the axial direction of the pair of connecting cylindrical portions, the female serration being capable of engaging by a serration engagement with a half portion in an axial direction of a male serration formed on an outer circumferential surface of an inner shaft, so as to connect the hollow torque transmission member to the inner shaft to enable torque transmission and relative displacement in the axial direction with respect to the inner shaft, such that the hollow torque transmission member functions as an outer tube of an intermediate shaft, the female serration is formed on an inner circumferential surface of the small diameter portion of the hollow material after forming the bellows portion.

19. The method for producing the hollow torque transmission member according to claim 16, wherein the bulge molding is hydroforming molding.

20. The method for producing the hollow torque transmission member according to claim 16, wherein a pair of taper portions is formed on both end portions in the axial direction of the thin thickness portion when forming the thin thickness portion, the pair of taper portions having a thickness that becomes larger towards a direction away from each other in the axial direction.

21. A method for producing a hollow torque transmission member comprising a pair of connecting cylindrical portions capable of being connected to other member so as to enable torque transmission and a bellows portion located between the pair of connecting cylindrical portions, the method comprising a step of:
forming a thin thickness portion all around a middle section in an axial direction of a hollow material, the thin thickness portion having a thickness in a radial direction smaller than a thickness in the radial direction of a portion that deviates on one side in the axial direction from the thin thickness portion of the hollow material and a portion that deviates on the other side in the axial direction from the thin thickness portion of the hollow material such that an outer diameter of the thin thickness portion is made larger than an outer diameter of the portion that deviates on the one side in the axial direction from the thin thickness portion, and is made smaller than an outer diameter of the portion that deviates on the other side in the axial direction from the thin thickness portion, and molding the bellow portion by expanding the thin thickness portion outward in the radial direction by bulge molding.

22. The method for producing the hollow torque transmission member according to claim 21, wherein a small diameter portion is provided on the one side in the axial direction of the hollow material and a large diameter portion is provided on the other side in the axial direction, and the thin thickness portion is formed in the large diameter portion.

23. The method for producing the hollow torque transmission member according to claim 21, wherein, in a case that a female serration is formed on an inner circumferential surface of a connecting cylindrical portion on one side in the axial direction of the pair of connecting cylindrical portions, the female serration being capable of engaging by a serration engagement with a half portion in an axial direction of a male serration formed on an outer circumferential surface of an inner shaft, so as to connect the hollow torque transmission member to the inner shaft to enable torque transmission and relative displacement in the axial direction with respect to the inner shaft, such that the hollow torque transmission member functions as an outer tube of an intermediate shaft, the female serration is formed on an inner circumferential surface of the small diameter portion of the hollow material after forming the bellows portion.

24. The method for producing the hollow torque transmission member according to claim 21, wherein an inner diameter of the thin thickness portion is made larger than an inner diameter of a portion that deviates in the axial direction from the thin thickness portion of the hollow material.

25. The method for producing the hollow torque transmission member according to claim 21, wherein the bulge molding is hydroforming molding.

26. The method for producing the hollow torque transmission member according to claim 21, wherein a pair of taper portions is formed on both end portions in the axial direction of the thin thickness portion when forming the thin thickness portion, the pair of taper portions having a thickness that becomes larger towards a direction away from each other in the axial direction.

27. A method for producing a hollow torque transmission member comprising a pair of connecting cylindrical portions capable of being connected to other member so as to enable torque transmission and a bellows portion located between the pair of connecting cylindrical portions, the method comprising a step of:
preparing a hollow material having a small diameter portion provided on one side in an axial direction of the hollow material and a large diameter portion provided on the other side in the axial direction,
forming a thin thickness portion all around a middle section in the axial direction of the large diameter portion of the hollow material, the thin thickness portion having a thickness in a radial direction smaller than a thickness in the radial direction of the other portion that deviates in the axial direction from the thin thickness portion of the hollow material, and
molding the bellow portion by expanding the thin thickness portion outward in the radial direction by bulge molding.

28. The method for producing the hollow torque transmission member according to claim 27, wherein, in a case that a female serration is formed on an inner circumferential surface of a connecting cylindrical portion on one side in the axial direction of the pair of connecting cylindrical portions, the female serration being capable of engaging by a serration engagement with a half portion in an axial direction of a male serration formed on an outer circumferential surface of an inner shaft, so as to connect the hollow torque transmission member to the inner shaft to enable torque transmission and relative displacement in the axial direction with respect to the inner shaft, such that the hollow torque transmission member functions as an outer tube of an intermediate shaft, the female serration is formed on an inner circumferential surface of the small diameter portion of the hollow material after forming the bellows portion.

29. The method for producing the hollow torque transmission member according to claim 27, wherein an inner diameter of the thin thickness portion is made larger than an inner diameter of a portion that deviates in the axial direction from the thin thickness portion of the hollow material.

30. The method for producing the hollow torque transmission member according to claim 27, wherein the bulge molding is hydroforming molding.

31. The method for producing the hollow torque transmission member according to claim 27, wherein a pair of taper portions is formed on both end portions in the axial direction of the thin thickness portion when forming the thin thickness portion, the pair of taper portions having a thickness that becomes larger towards a direction away from each other in the axial direction.

32. A method for producing a hollow torque transmission member comprising a pair of connecting cylindrical portions capable of being connected to other member so as to enable torque transmission and a bellows portion located between the pair of connecting cylindrical portions, wherein a female serration is formed on an inner circumferential surface of a connecting cylindrical portion on one side in the axial direction of the pair of connecting cylindrical portions, the female serration being capable of engaging by a serration engagement with a half portion in an axial direction of a male serration formed on an outer circumferential surface of an inner shaft, so as to connect the hollow torque transmission member to the inner shaft to enable torque transmission and relative displacement in the axial direction with respect to the inner shaft, such that the hollow torque transmission member functions as an outer tube of an intermediate shaft,
the method comprising a step of:
forming a thin thickness portion all around a middle section in the axial direction of the hollow material, the thin thickness portion having a thickness in a radial direction smaller than a thickness in the radial direction of the other portion that deviates in the axial direction from the thin thickness portion of the hollow material, molding the bellow portion by expanding the thin thickness portion outward in the radial direction by bulge molding, and
subsequently forming the female serration on an inner circumferential surface of the small diameter portion of the hollow material.

33. The method for producing the hollow torque transmission member according to claim 32, wherein an inner diameter of the thin thickness portion is made larger than an inner diameter of a portion that deviates in the axial direction from the thin thickness portion of the hollow material.

34. The method for producing the hollow torque transmission member according to claim 32, wherein the bulge molding is hydroforming molding.

35. The method for producing the hollow torque transmission member according to claim 32, wherein a pair of taper portions is formed on both end portions in the axial direction of the thin thickness portion when forming the thin thickness portion, the pair of taper portions having a thickness that becomes larger towards a direction away from each other in the axial direction.
